(19) United States
(12) Patent Application Publication
(10) Pub. No.: US 2008/0216615 A1
(43) Pub. Date: Sep. 11, 2008

(54) Structure of pliers

(76) Inventor: Ming-Chieh Wu, Taichung (TW)

Correspondence Address: WU, MING-CHIEH, P.O. BOX 215, TAICHUNG, 40099, TW

(21) Appl. No.: 11/723,218

(22) Filed: Mar. 19, 2007

(30) Foreign Application Priority Data
Mar. 9, 2007 (TW) 096203912

(51) Int. Cl. B25B 7/16

(52) U.S. Cl. 81/368

(57) ABSTRACT

This invention is to propose an improved structure of pliers that can clip objects of various shapes easily and tightly. It comprises: a recessed main body that mounts, in one side, with a fixed pliers jaw and a movable pliers jaw, and collaborates with an adjusting screw in the other side. The movable pliers jaw is also, in another end, mounted with a pressing lever that also mounts with an elbow device and a releasing lever. Further, a spring is set between the main body and movable pliers jaw. The improved feature of this invention is that both the fixed and movable pliers jaws have toothed faces in their front ends that can engage firmly with each other, and form a proper-sized room to clip working objects of various shapes firmly and tightly, and also, the toothed faces of both jaws can used to clip string-shaped objects to perform tasks as necessary.

### BACKGROUND OF THE INVENTION

This invention relates to an improved structure of pliers that can clip polygon objects firmly and tightly. (Please note that following notations in this field are that of associated prior art.) In the example of a prior art (U.S. Pat. No. 5,377,567 [symbol] BICYCLE TOOL [symbol] ), its problem is that although the third contacting portion 45 of the first jaw element 16 collaborates with first and second contacting portions 41, 43 to clip working objects, it just works better for hexagon objects. When an object is round or polygon-shaped, it would be hard to be clipped because the contacting faces are flat, making the invention flawed in this respect.

Another example of a prior art (U.S. Pat. No. 57,143,671 B1 [symbol] LEVER-WRENCH PLIERS [symbol] ), the movable jaw 20 sets a toothed clamping face 51 at its jaw tip 50, and when the toothed clamping face 51 engages with the mouth 40, it engages with the first clamping face 41 of the mouth 40. However, the collaboration between the toothed clamping face 51 and V-shaped mouth 40 still will encounter the same problem as preceding example.

With long time investments in researches and experiments, the inventor finally found an improved structure that can prevent aforementioned problems that prior arts encounter, and thus hereby proudly files application of patent to protect intellectual property.

### BRIEF SUMMARY OF THE INVENTION

This invention is to propose an improved structure of pliers that can clip objects of various shapes easily and tightly. To this end, such an improved structure of pliers comprises: a main body that mounts, in one side, with a fixed pliers jaw and a movable pliers jaw, and collaborates with an adjusting screw in the other side. A spring is set between the main body and movable pliers jaw.

The structure further comprises a pressing lever that mounts with an elbow device in its front side and a releasing lever close to its middle. One end of the releasing lever leans on the elbow device, and the other end keeps certain proper distance from the bottom end of the pressing lever. The improved feature of this invention is that both the fixed and movable pliers jaws have toothed faces in their front ends that can engage firmly with each other, and form a proper-sized room to clip working objects of various shapes firmly and tightly, and also, the toothed faces of both jaws can used to clip string-shaped objects to perform tasks as necessary.

### BRIEF DESCRIPTION OF THE DRAWINGS

FIG. 1—an exploded view of preferred embodiment

FIG. 2—a perspective view of preferred embodiment

FIG. 3—a front view of preferred embodiment

FIG. 4—a partial close-up view of preferred embodiment

### DETAILED DESCRIPTION OF THE INVENTION

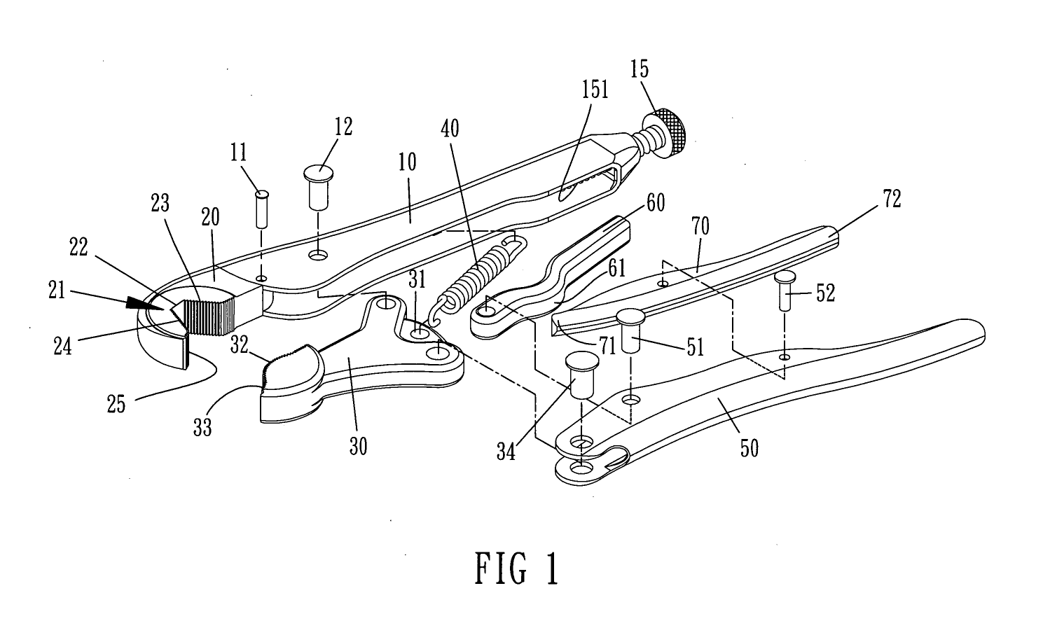

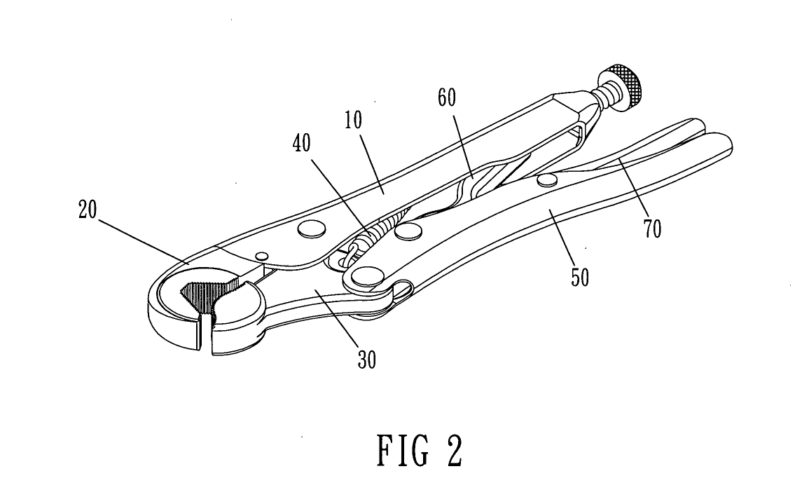

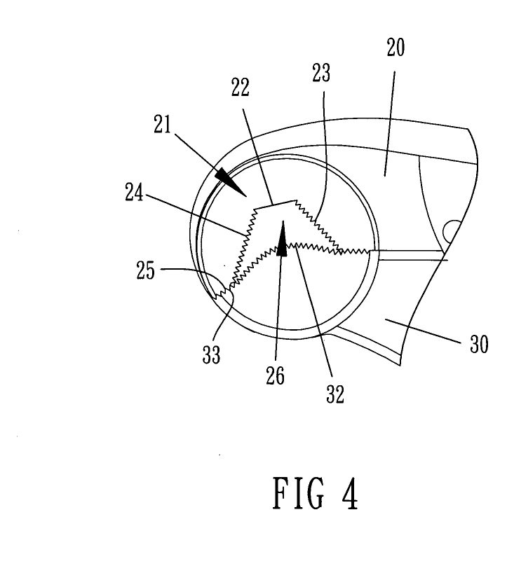

Below please refer to descriptions of the preferred embodiment with references to attached drawings. First, as shown in FIG. 1-4, an improved structure of pliers comprises a main body 10, recessed in one side (shown in FIG. 1), that mounts with fixed pliers jaw 20 and movable pliers jaw 30 with two pins 11, 12, and has an inner hook 13 to hook one end of a spring 40, and female threads 14 at its bottom for threading with an adjusting screw 15 partially housed inside the recess of the main body 10. The spring 40 is a stretching spring. The fixed pliers jaw 20 has, in one side, a V-shaped recess 21 with a flat face 22 in the middle side, grooved faces 23, 24 on both lateral sides and toothed face 25 its front end.

With one side housed and mounted inside the recess of the main body 10, the movable pliers jaw 30 has a positioning hole 31 at the middle bottom for being hooked by the spring 40, and mounts with a pressing lever 50 on the other side with pin 34. Moreover, the movable pliers jaw 30 has a convex end 32 that also has toothed faces 33, the part that can engage with the V-shaped recess 21 at toothed face 25. When toothed faces 33 and 25 engage, a properly sized room 26 would be formed for clipping purpose.

An elbow device 60, mounted on the pressing lever 50 with a pin 51 in its front side, is properly curved 61 close to its middle, and its bottom end can lean against the adjusting screw 15. Further, a releasing lever 70 is mounted on the pressing lever 50 close to its middle with a pin 52. The front end 71 of the releasing lever 70 leans on the curved part 61 of the elbow device 60, and the other end (bottom end 72) keeps certain distance from the bottom of the pressing lever 50, so that it can be pressed against the pressing lever 50 to release the locking.

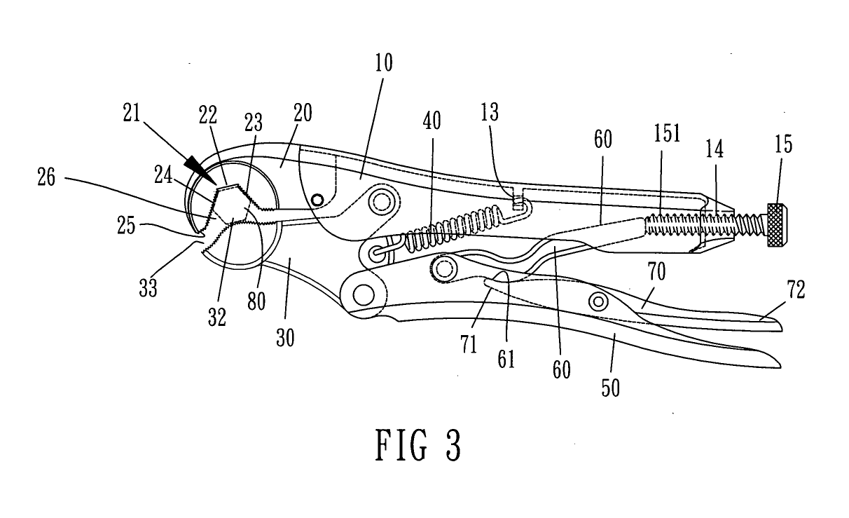

With aforementioned components and structures, pressing the pressing lever 50 will move the movable pliers jaw 30 outwards, making the room 26 between the two jaws 20, 30 larger to clip polygon objects 80 (as shown in FIG. 3) more easily and tightly with flat face 22, grooved faces 23, 24 and the convex end 32.

Here please be described of functionality of the adjusting screw 15, spring 40, elbow device 60, and releasing lever 70. When the pressing lever 50 is pressed against the main body 10, it's not just only that the movable pliers jaw 30 will move outwards, but also that the elbow device 60 will move towards the movable pliers jaw 30 and the spring 40 will be stretched. After the object 80 is clipped by the two jaws 20, and 30, the adjusting screw can be adjusted by threading until its top pushes tightly against the bottom of the elbow device 60. Thus, the pliers can clip the object tightly without extra forces being exerted. If the object is to be released, one can press the bottom end 72 of the releasing lever 70 against pressing lever 50, and then the front end 71 of the releasing lever 70 will push the elbow device 60, making its bottom move out of the adjusting screw 15 and, with the pulling power released from the stretched spring 40, making movable pliers jaw 30 back to its original standby position.

On the other hand, when the two jaws 20 and 30 engage, the toothed face 25 will engage with toothed face 33 so as to clip working object tightly, or even shape into teeth-shaped on surface when the working object is a string.

With all aforementioned, the invention deserves grant of a patent based on its capability of industrial application and absolute novelty. The example illustrated above is just an exemplary embodiment for the invention, and shall not be utilized to confine the scope of the patent. Any equivalent modifications within the scope of claims of the patent shall be covered in the protection for this patent.

1. An improved structure of pliers comprising:
A main body, recessed in one side, that mounts with a fixed pliers jaw in front end and collaborates with an adjusting screw in its bottom end;
a pressing lever that mounts with a movable pliers jaw and an elbow device in its front side, and a releasing lever close to its middle;
wherein the said movable pliers jaw also mounts with the said main body and a spring is set between the said movable pliers jaw and main body; and the said elbow device, near its middle, is curved staying against the front end of the said releasing lever, and its bottom end stays against one end of the said adjusting screw; the feature is that the said fixed pliers jaw is recessed, which can collaborate with the convex end of the said movable pliers jaw to grip any workpiece;
wherein the said recess of the said fixed pliers jaw is V-shaped and has grooved faces on its both lateral sides;
wherein the said recess of the said fixed pliers jaw has a flat face in the middle section;
wherein both the said fixed and movable pliers jaws have toothed faces in their front ends to engage with each other.

2-4. (canceled)
